(19) United States
(12) Patent Application Publication
(10) Pub. No.: US 2008/0052184 A1
(43) Pub. Date: Feb. 28, 2008

(54) Systems and methods for product authentication and warranty verification for online auction houses

(75) Inventors: Peter J. Junger, Redmond, WA (US); Teresa Wong, Redmond, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America Inc., Redmond, VA (US)

(21) Appl. No.: 11/892,415

(22) Filed: Aug. 22, 2007

Related U.S. Application Data
(60) Provisional application No. 60/839,122, filed on Aug. 22, 2006.

(51) Int. Cl. G06Q 30/00

(52) U.S. Cl. 705/26

(57) ABSTRACT

The example embodiments herein relate to the field of electronic registration (ER) of purchased products and, more particularly, to an improved electronic registration system which enables online buyers and sellers (e.g. those participating in online auctions) to take advantage of the benefits associated with ER systems. The ER techniques enable buyers to determine whether the product for sale, for example, has been purchased through authorized channels, was stolen, is covered under a warranty, etc. Such techniques may be used with existing brick-and-mortar stores as well as online stores. Value may be added for buyers, sellers, auction houses, manufacturers, and/or contract service partners.

### CROSS-REFERENCE TO RELATED APPLICATION

This application claims the benefit of U.S. application Ser. No. 60/839,122, the entire contents of which are hereby incorporated herein by reference.

### FIELD

The example embodiments herein relate to the field of electronic registration (ER) of purchased products and, more particularly, to an improved electronic registration system which enables online buyers and sellers (e.g. those participating in online auctions) to take advantage of the benefits associated with ER systems. The ER techniques enable buyers to determine whether the product for sale, for example, has been purchased through authorized channels, was stolen, is covered under a warranty, etc.

### BACKGROUND AND SUMMARY

Recently, electronic registration (ER) of product transactions has become available for the purpose of reducing unauthorized returns of purchased products and/or unauthorized warranty repair on purchased products. Electronic product registrations systems provided for this purpose are disclosed in, for example, U.S. Pat. Nos. 5,978,774, 6,018,719 and 6,085,172, the disclosures of which are all incorporated by reference herein in their entirety. The electronic registration system relies on the use of a unique identifier, such as a serial number linked to a UPC (and/or RFID) or its equivalent, for each product that is purchased. The serial number is obtained at the point of sale for inclusion in a registration database, together with other information, such as a date of transaction. This database can then be accessed in connection with an attempted product return/warranty transaction for the purpose of determining if the product qualifies for return/warranty under applicable return/warranty criteria under which the product was originally sold. Such electronic systems may also be used in connection with repair and/or exchange transactions, in addition to returns, by enabling an accurate determination as to whether the product qualifies for any of these actions under the appropriate policies and criteria under which the product was originally sold.

The ER system uses pre-established return/repair policies and procedures that are programmed into the ER system so that the system can perform a check when a product is presented for return to determine if the product qualifies for return, replacement and/or warranty repair based on sales transaction information available in the ER system for the particular product at issue. Thus, known ER systems include a database of return qualification information (or warranty/replacement criteria) for various manufacturers and/or retailers which enables the system to make an accurate determination with respect to whether or not a product actually qualifies for return (or warranty/replacement) based on the appropriate criteria and at the time the product is actually presented for return. Such ER systems have greatly reduced improper and fraudulent returns and warranty claims.

While such ER systems have proven to be very useful in their current forms, additional improvements in the system are still desired to make such ER systems more flexible in operation in order to benefit customers, retailers and manufacturers. For example, there is a potentially continual need to further reduce product return costs, particularly costs relating to processing proper product returns. Moreover, a number of traditional problems are exacerbated in the online world, especially with online auction houses. These challenges are posed by features inherent in online transactions, such as, for example, the impersonal nature thereof. While traditional business may be transacted at “arms-length,” an online buyer may have no idea as to where the online seller is even located. Whereas a traditional buyer may inspect goods in person and rely on a handshake to verify the integrity and authenticity of the goods, an online buyer essentially is at the mercy of the online seller insofar as the online buyer must take the word of the online seller.

These inherent disadvantages of online sales manifest themselves in various ways. For example, online auction houses have been criticized for being an intermediary for the fencing of stolen goods; the selling of gray-market goods; and, the fraudulent returning of items obtained online to retailers for cash, in-store credits, or exchanged new products. Additionally, as noted above, online auction house buyers often are uncertain of the validity of the seller's claims. For example, a buyer may not have information related to product warranty, product age, product history (e.g. whether stolen, counterfeit, or the like), etc. There also are cases where the online seller is acting as an agent on behalf of the person actually owning the product and, in such cases, the online seller may not even be aware of the status of the item the seller is posting.

One example is reported in an article in The Register published on May 17, 2005 by John Leyden entitled “Burgled mum finds stolen iPod on eBay.” The article describes how thieves broke into a home and stole an Apple iBook laptop, a digital camera, an amethyst dinner ring, and an ipod. The items subsequently appeared for auction on eBay. Because the iPod bore a unique inscription, it was traced back to the rightful owner. Unfortunately, however, other items may not be so readily identifiable.

Another example was reported on the Oregon station KPTV. An online synopsis from Nov. 18, 2005 available at

http://www.kptv.com/Global/story.asp?S=4137050&nav=muni156_{—}2 described a scam by which the accused allegedly replaced the bar codes of expensive Lego products to purchase them cheaply and then resell them on eBay. Detectives believe that the accused may have scammed stores out of $150,000, in scams runs from Arizona, California, Nevada, Oregon, and Utah.

While some auction houses have used serial numbers to a limited extent, such use of serial numbers has not been in connection with an independent third party. Therefore, there has been no verification of serial number information. As a result, prior use of serial numbers, especially in auction houses, has not addressed and/or solved the problems to which the instant application is directed.

Thus, it will be appreciated that there is a need in the art for a system and/or method for overcoming one or more of these or other disadvantages. Accordingly, a feature of the example embodiments herein relates to systems and/or methods for discouraging stolen items and/or items obtained through an illicit source from being posted and sold through online sites (e.g. online auction houses). Another feature relates to discouraging the return of such items to traditional retailers and eTailers.

One advantageous aspect of the example embodiments herein relates to the ability to closely scrutinize, and provide additional product and support/service information for, posted items. Because of this aspect, an online buyer may be willing to pay a premium price over those products that have not been screened through these techniques.

Another aspect relates to the availability of online sellers (e.g. online auction houses) to become more responsible corporate citizens and/or to deflect industry-wide criticism for being an intermediary for fencing stolen goods and selling gray-market goods. An announcement of such techniques may help to deter some of stolen, counterfeit, or otherwise unscrupulous products from being posted at all.

According to certain example embodiments, a system for electronic product registration is provided. An online auction house includes a seller interface configured to accept product information for at least one product to be sold by at least one seller, and a buyer interface configured to allow at least one buyer to search for and/or purchase a product for sale by a seller to be bought by a buyer. An electronic registration database includes an entry for each of a plurality of products. The electronic registration database is populated with product information for each said product in the electronic registration database and is populated by at least one of a retailer, a manufacturer, an authorized party, and an auction house seller. An electronic registration clearinghouse is configured to issue a certificate to certify for each product entered into the seller interface whether each said product should be offered for sale by the auction house in dependence on the product information stored in the electronic registration database. The auction house lists products having certificates for sale.

According to certain other example embodiments, a method of operating an online auction house is provided. Product information for a product to be sold by a seller is accepted from a seller interface of the online auction house. The product information for the product to be sold is compared to product information stored in an electronic registration database populated with product information for a plurality of products. The electronic registration database is populated by at least one of a retailer, a manufacturer, an authorized party, and an auction house seller. A certificate is associated with the product to be sold in dependence on the comparing step. Those products that have certificates associated therewith are listed for sale.

According to still other example embodiments, an electronic registration clearinghouse for use with an online auction house is provided. Comparing programmed logic circuitry is configured to compare product information for a product to be sold to product information stored in an electronic registration database populated with product information for a plurality of products, with the electronic registration database being populated by at least one of a retailer, a manufacturer, an authorized party, and an auction house seller. Certifying programmed logic circuitry is configured to issue a certificate to certify, for each product entered into a seller interface of the auction house, whether each said product should be offered for sale by the auction house in dependence on a comparison to product information stored in the electronic registration database.

It will be appreciated that these aspects and embodiments may be combined in various combinations and sub-combinations to achieve yet further example embodiments. Also, it will be appreciated that the example embodiments herein may be implemented as any suitable combination of programmed logic circuitry including, for example, hardware, software, firmware, etc.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a schematic block diagram illustrating an example of an overall electronic product registration (ER) system that may be used in accordance with an example embodiment;

FIG. 2 is a high level flow chart of some of the main steps performed in accordance with prior electronic product registration (ER) systems;

FIG. 3 is a schematic diagram illustrating components which may be used in connection with an example embodiment;

FIG. 4 is a simplified block diagram of an online auction house interacting with an ER system in accordance with an example embodiment;

FIG. 5 is an exemplary screen shot of a user interface for listing an item for sale in accordance with an example embodiment;

FIG. 6 is an exemplary screen shot of a user interface for displaying sold items in accordance with an example embodiment;

FIG. 7 is an exemplary screen shot of a user interface for displaying items to be purchased in accordance with an example embodiment;

FIG. 8A is an illustrative flowchart showing how an ER database may be built for a electronic point-of-sale, in accordance with an example embodiment; and,

FIG. 8B is an illustrative flowchart showing how postings may be prevented for products that are determined to be stolen, counterfeit, or the like;

### DETAILED DESCRIPTION

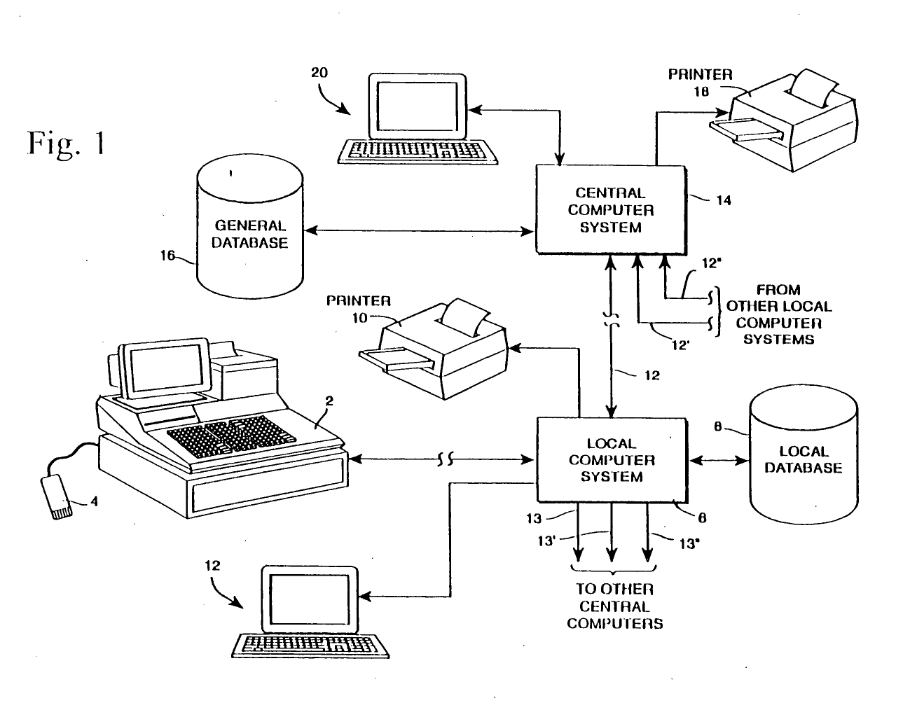

An example of one type of electronic product registration (ER) system that is preferably used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. As discussed below in greater detail, the central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an Internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired. If so, the store associate is prompted to enter the serial number of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as individual production identification information.

Once the serial number is entered, a check may be made to ensure that the serial number is valid. If not, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, original policies are defined for products when the are first sent to the retailer by the vendor. The ER system preferably includes the policies of both the vendor and the retailer and enables the policies of both parties to be easily and conveniently enforced.

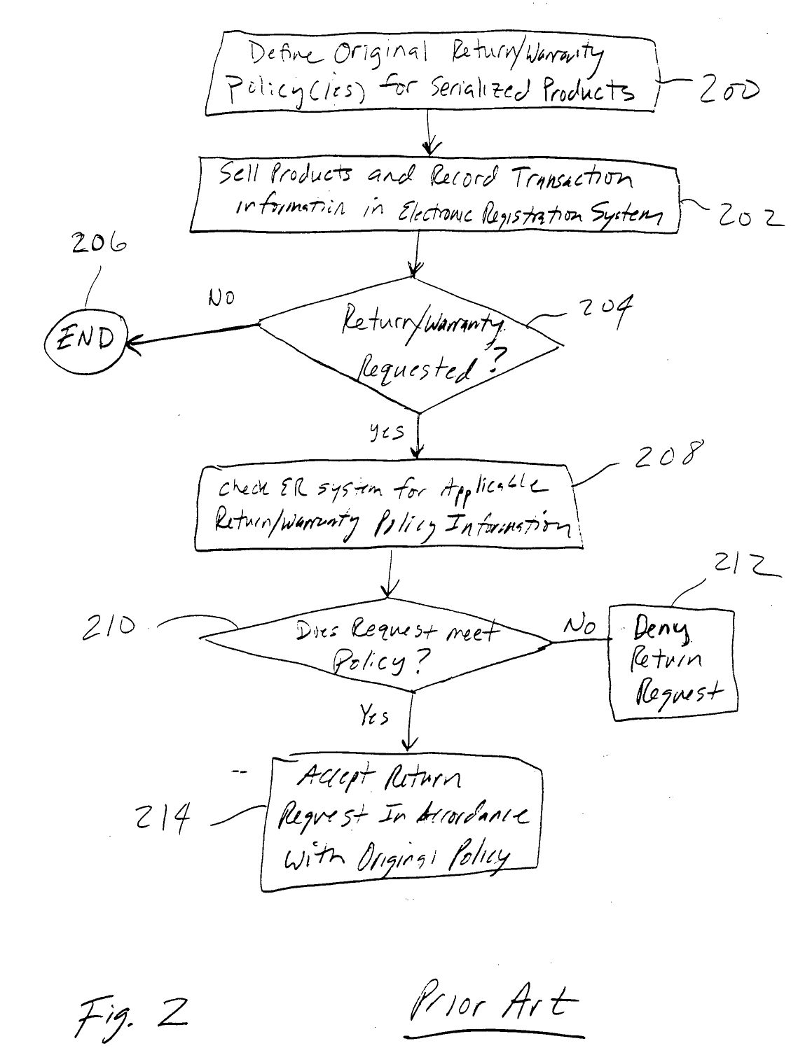

FIG. 2 shows the main steps performed in connection with conventional ER systems. As shown in FIG. 2, the return/warranty policy(ies) are defined for serialized products and entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk could decide, for some reason, to ignore the ER information and accept the product anyway.

There is, however, no mechanism by which online buyers and sellers (e.g. using an online auction house) can take advantage of similar ER techniques. Online purchasers may be located throughout the country. These purchasers may purchase goods using their home computers instead of, or in addition to, at retail stores. Additionally, in the case of online auction houses, sellers may be located virtually anywhere in the country, as well, regardless of the actual locations of manufacturer warehouse 5 and retail regional warehouse 1. Because of this highly distributed selling and purchasing environment, it will be appreciated that the system shown in FIGS. 1-2, while good for initial brick-and-mortar sales, need improvements for, for example, online sales, subsequent transfers, online returns, etc.

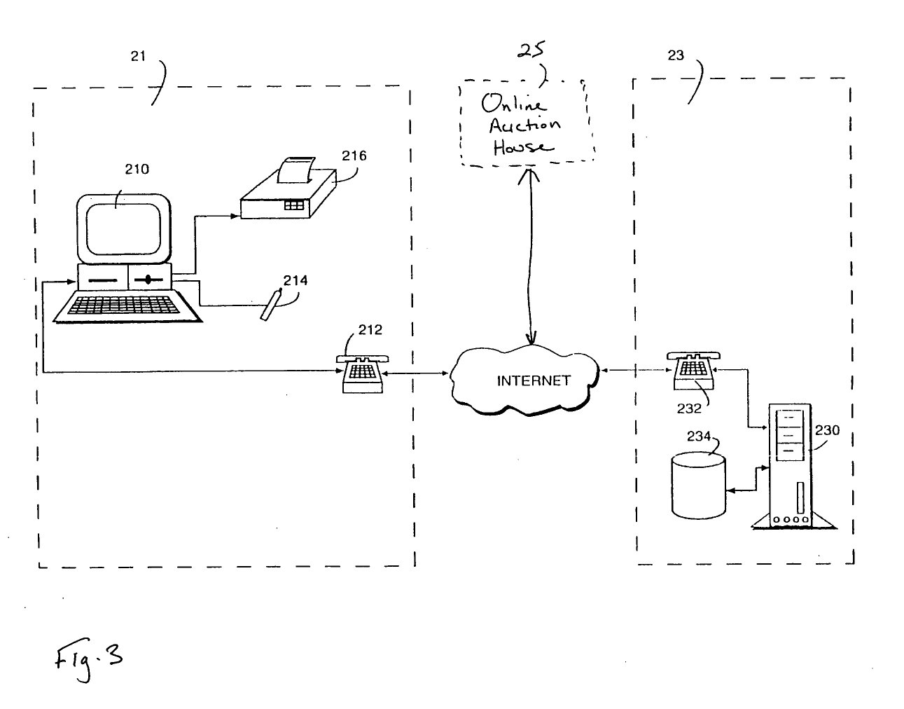

FIG. 3 is a schematic diagram illustrating components which may be used in connection with an example embodiment. The system of FIG. 3 includes a return side portion 21 and a manufacturer side portion 23 which are operable to communicate over an Internet connection 25. Briefly, the return side portion 21 may include a personal computer 210 that includes, for example, a processor with an associated memory and operating system. The personal computer also may include a modem for direct connection to an Internet provider through a dedicated telephone connection 212. Alternatively, an Internet connection may be made by the personal computer 210 over a corporate network. Also, it may be possible to utilize a direct telephone linked by modem between the return side portion 21 and the manufacturer side portion 23 or even a hardwired connection.

A bar code scanner 214 is provided for scanning bar coded SKU and, possibly, serial numbers for returned products. Additionally, a printer 216 is provided for printing transaction records and, if desired, printed versions of return authorizations from the manufacturer. It will be appreciated that manually prepared return authorization forms may be used as an alternative to printed return authorizations.

The manufacturer side portion 21 includes a computer system 230 having an associated data storage unit 234 for storing an electronic product registration database. The manufacturer side computer system 230 is capable of communicating with the return side portion 21 over an Internet connection though telephone connection 232. As noted previously, other communication techniques between the manufacturer side portion 23 and the return side portion 21 may also be utilized.

After the regional retailer return facility receives products for return to the manufacturer, the return side portion 21 may access the manufacturer side portion 23 to screen the products for compliance with return requirements and to obtain pre-authorization of the returns. In particular, the return side computer 210 connects to the manufacturer side computer 230 by way of the Internet or through the appropriate communication techniques. In the present example embodiment, the manufacturer side computer maintains a world wide web page for access by the regional return center. Password protection may be provided to ensure only authorized retailers are able to access return pre-authorization features in accordance with the present invention. For example, each return center location that is permitted access to the pre-authorization features may be assigned a location identification code and a password. In such a case, both the location identification code and the password would be required before access is granted to the product return screening program.

Unlike conventional systems, the system of FIG. 3 also includes online auction house portion 25, which will be described in greater detail below. Briefly, however, online auction house portion 25 may function like return side portion 21, insofar as online auction house portion 25 may communicate with manufacturer side portion 23. For example, online auction house portion 25 may retrieve and/or update product information stored in data storage unit 234.

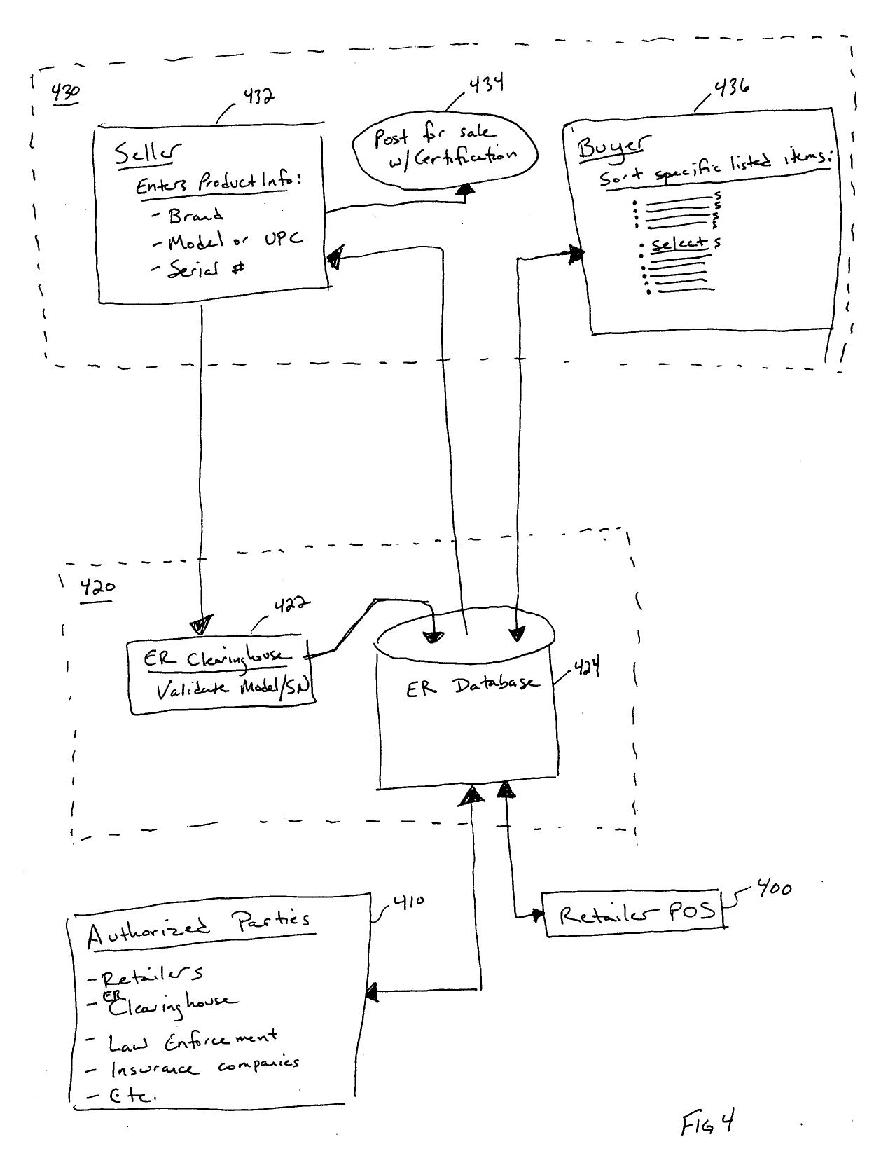

Conventional auction houses and their applications may be modified to take advantage of, and expand on, the unique features offered by ER systems. For example, FIG. 4 is a simplified block diagram of an online auction house interacting with an ER system in accordance with an example embodiment. Retailer Point-of-Sale (POS) 400 may populate ER database 424 with products for sale, as is known in the art. Retailer POS 400 also may update ER database 424 when sales are made, products are returned or authorized for return, etc., also as is known in the art. Authorized parties 410 may flag certain items in ER database 424. For example, authorized parties 410 may flag stolen items, missing items, items that should be watched, etc. It may also indicate the location from which the item was lost, stolen, etc. Such information may be useful, for example, because if it were lost from a packing crate it should not appear at a retail store. ER database 424 also may indicate the entity that flagged the particular item. Authorized entities may include, for example, retailers, an ER clearinghouse, law enforcement personnel, insurance companies, etc.

The operations typical of an online auction house 430 will now be described in greater detail. A seller may use a seller interface 432 to enter product information relating to the item to be auctioned off. Such information may include, for example, brand, model and/or UPC, serial number, etc. Based on a submission, a serial number lookup may take place. The serial number lookup may trigger a ER clearinghouse module 422 to interface with ER database 424 to validate the model/serial number pairing.

Status information included in ER database 424 may be relayed back to the seller, after a successful lookup. Such status information may include, for example, warranty information, locations of authorized service center locations, whether the product is reported stolen, etc. Some, all, or none of this information may be presented to the seller. Additionally, some, all, or none of this information may be relayed transparently to an authorized party (e.g. a law enforcement entity) based on, for example, whether the item is flagged as stolen.

If the lookup is successful, the item may be posted for sale in step 424. The posting may include a certification (e.g. a unique certificate, icon, logo, etc.) to identify that the product underwent ER database scrutiny.

Buyers may use a buyer interface 436 to browse and/or search for various products available via the online auction house. The buyers may be able to sort the various listed items based on whether they have an associated ER database certification. Once a product is selected for additional information, similar status information as that described above may be relayed to the prospective buyer. Thus, the buyer may be able to make a more informed decision as to whether to purchase the product. ER database 424 may update a lookup count to reflect, for example, the value of the certification service.

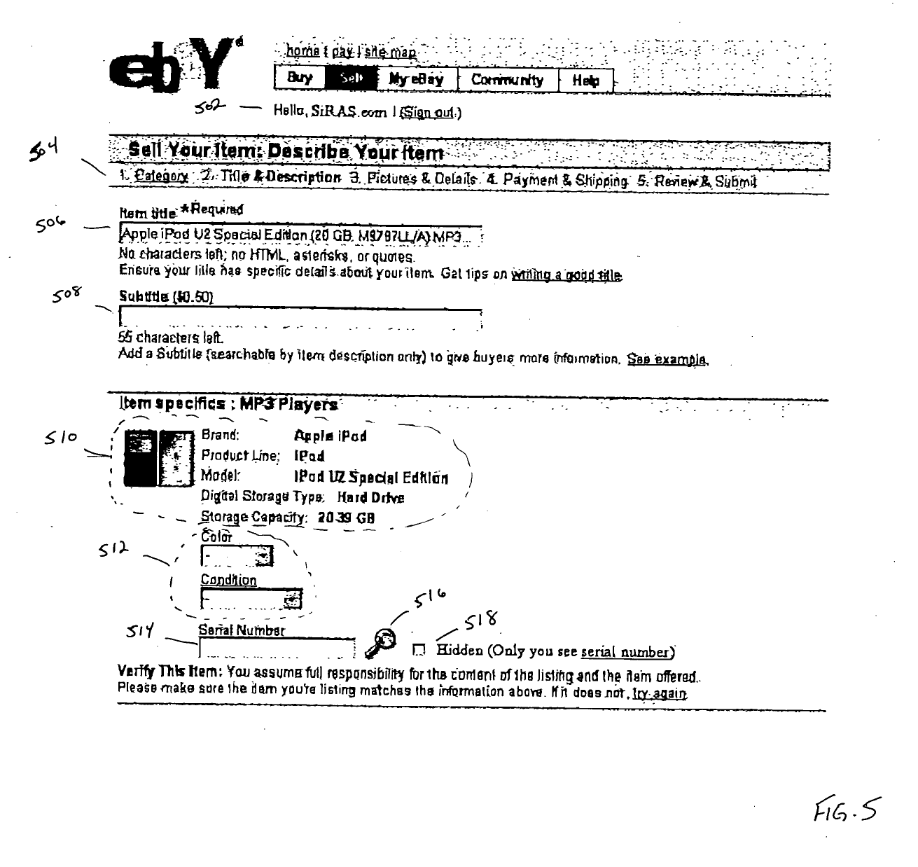

FIG. 5 is an exemplary screen shot of a user interface for listing an item for sale in accordance with an example embodiment. Name 502 identifies the user (e.g. a logged-in registered user) about to list the item. Breadcrumbs 504 help the user to navigate through the various steps of the listing process. Item title 506 enables the user to input a descriptive title for the item to be sold. In this case, the item is an special edition Apple iPod. An optional subtitle may be specified in subtitle area 508. The item specifics are listed in area 510. It will be appreciated that the information shown in FIG. 5 is provided by way of example and without limitation. In certain example embodiments, other information may be present apart from, or in addition to, that shown in area 510. Additional information may be provided in area 512. Again, other information may be present apart from, or in addition to, that shown in area 512, depending on, for example, the particular embodiment, the type of product being sold, etc.

The user may input a serial number in serial number block 514. This would allow the user to certify the item with the ER system. The certification process may be actuated by clicking on the magnifying lens button 516. Additionally, the user may opt to keep the serial number information hidden. In certain example embodiments, it may be advantageous to keep the serial number information hidden. This is because counterfeiters, bootleggers, and the like may troll for known serial numbers to attach to, or associated with, their unscrupulous wares. It will be appreciated that the illustrative user interface shown in FIG. 5 (and corresponding arrangements not explicitly shown but within the scope of the example embodiments) may satisfy the requirements of seller interface 432 shown in FIG. 4.

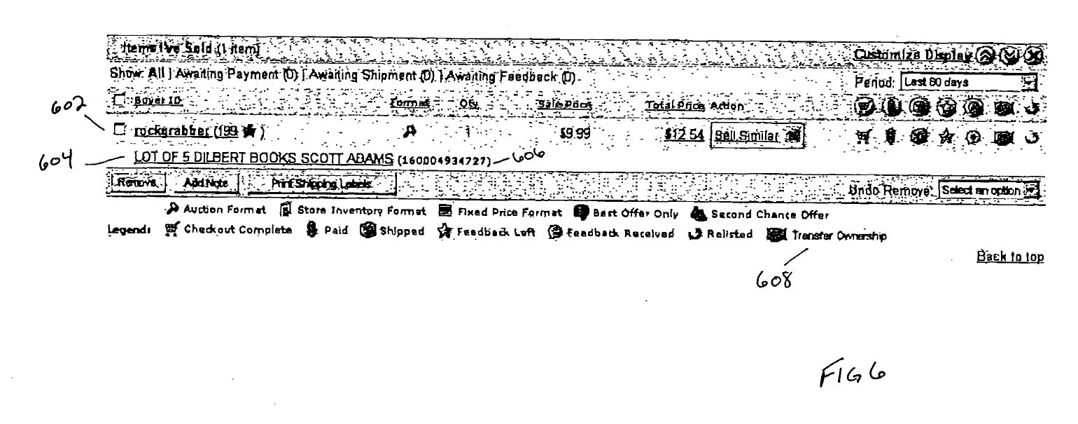

FIG. 6 is an exemplary screen shot of a user interface for displaying sold items in accordance with an example embodiment. Purchase information is shown in area 602. Purchase information may include, for example, a buyer id, a quantity, sale price, total price, and one or more other status indications as described in the legend. In addition, the description provided by the seller may appear in area 604, and the associated serial number 606 may be shown. Also, as will be described in greater detail below, the ownership transfer status 608 also may be indicated.

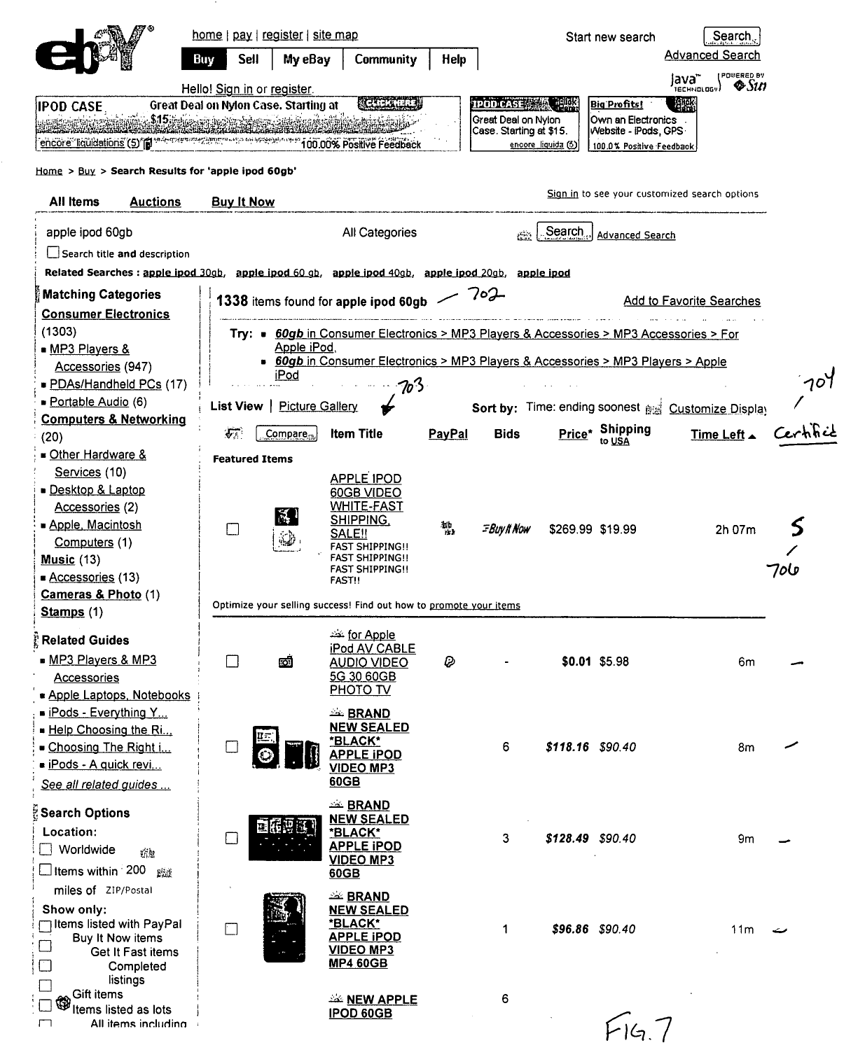

FIG. 7 is an exemplary screen shot of a user interface for displaying items to be purchased in accordance with an example embodiment. In addition to conventional search displays for traditional online actions which display, for example, search terms 702, and search results 703 (which may comprise, for example, a number of bides, price, shipping, time left to bid, etc.), certain example embodiments may provide further information to prospective buyers. For example, certified column 704 may indicate whether products have undergone a check with the ER database as described above in connection with FIG. 5. Those products that have may be listed first (e.g. as featured items), and a corresponding certificate symbol 706 may also be displayed to graphically represent the completion of the certification process. Thus, searches and/or purchases may be limited to those items that have been screened and/or certified, as indicated, for example, by a unique identification and/or flag. Additional information may thus be available regarding these products.

One general concern manufacturers and retailers have relates to so-called B-goods. B-goods are variously defined, but they generally represent goods that are sold, returned, and subsequently resold. Remanufactured goods typically are one example of B-goods. Another general concern relates to gray-market goods. Gray-market goods generally are those goods that are sold via an unauthorized distribution channel. For example, exported products may be re-imported and sold domestically. Even though these products are legitimate in the sense that they were produced by a manufacturer, they are considered gray-market goods because they entered the market through a unapproved channel. In another example, many manufacturers offer incentives for retailers who purchase their products in large lots. When the retailers purchase such large lots and cannot sell them, they may resell them to other dealers, post them on online auctions, etc.

An ER database may be built and maintained according to the techniques disclosed in the above-referenced U.S. patents. Additionally, manufacturers may pre-register their shipments to their retailer customers so that the ER system may provide a listing of items that ultimately appear on auction houses, thus enabling trans-shipment tracking, etc.

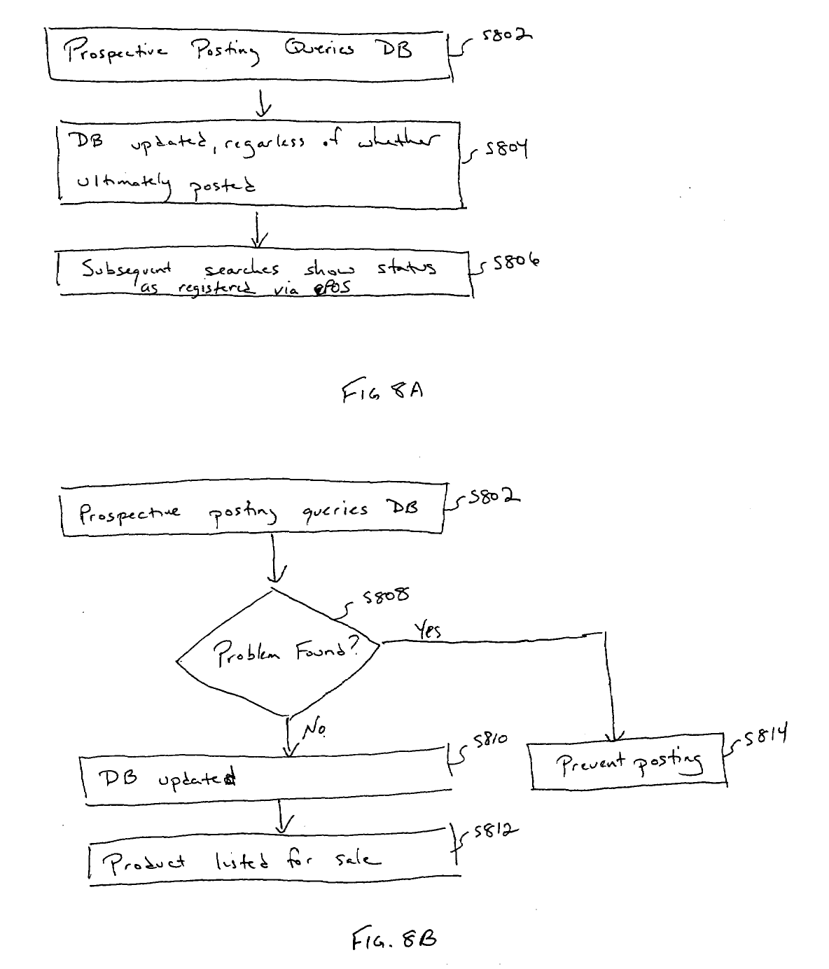

In the alternative, or in addition, FIG. 8A is an illustrative flowchart showing how an ER database may be built for a electronic point-of-sale (ePOS), in accordance with an example embodiment. In FIG. 8A, a prospective posting queries the ER database in step S802. The database is undated, regardless of whether the item ultimately is posted in step S804. In step S806, subsequent searches show the status as registered via an ePOS. It will be appreciated that this process may be made to mirror the brick-and-mortar examples of building an ER database, the techniques of which are known.

In the alternative, FIG. 8B is an illustrative flowchart showing how postings may be prevented for products that are determined to be stolen, counterfeit, or the like. In FIG. 8B, a prospective posting queries the ER database in step S802. Step S808 determines whether there is a problem with the posting. For example, a problem may be indicative of an unauthorized distribution channel, an item reported stolen, an invalid serial number (potentially indicating a mistake, a counterfeit, or the like), etc. As described above, various authorities may help flag items as stolen, as being lost, etc. Additionally, manufacturers may be able to specify whether a particular serial number has been authorized to proceed through a given channel. If no problems are found, the database may be updated in step 810, and the product may be listed for sale in step S812. If there is a problem, the posting may be prevented altogether by step S814. A resolution center associated with the online auction house may have easy access to information and/or anomalies to help resolve buyer/seller issues more quickly (e.g. when a product cannot be posted). Audits such as these may be performed when products are listed, at original points of sale, when shipment are made and/or delivered, etc. Such audits also may be periodic and/or unrelated to listings and/or shipments.

It will be appreciated that certain rules may apply in addition to the basic process described herein. For example, in the case where a serial number is close but not exact, the potential seller may be prompted to reenter the serial number. In certain example embodiments, the prospective seller may not know whether the item is allowed and in still further example embodiments, an appropriate authority may be transparently notified of a potential theft. It also will be appreciated that because the example embodiments described herein may function as an ePOS with analogs to conventional ER systems, fraud and/or counterfeiting may be tracked and/or traced both online and at actual brick-and-mortar stores.

Systems and methods according to these techniques may convey a number of associated advantages for buyers, sellers, retailers, manufacturers, etc. One advantage relates to reducing the ease with which online auction house traded items may be returned to retailers and/or eTailers, and it may reduce the number of stolen and/or gray-market goods from being posted in an online auction. For example, these advantages may be achieved through the method described in relation to FIG. 8B.

Sellers may be incented to certify their products with an ER system according to the example embodiments herein. This is because, for example, buyers may opt to view only certified products, or they may order products based on whether they are certified. This may be true regardless of whether sellers opt to make associated serial numbers visible to potential buyers. Sellers also may realize a premium price because of value-added features described in further detail below.

Regarding B-goods in particular, prospective buyers may be willing to pay a premium for goods that have not been used extensively, been through a number of different owners, sat on the market for an excessive amount of time, etc. Certain example embodiments are advantageous because they provide a way of substantiating a seller's claims.

Additionally, value-added content such as, for example, an exact amount of warranty left on a product, extended service plan availability, local factory authorized service providers and manufacturer URL linked to customer support availability, toll-free numbers, etc. may be provided. In certain example embodiments, the exact details may be not be fully displayed to prevent trolling for serial numbers, POS data, date sold, etc. that could help a person counterfeit and/or fraudulently use such information. In such example embodiments, the full information may become available to a buyer once the purchase is consummated. In cases where full information is not made available, simplified information may be available. For example, a various gauges (e.g. a gas gauge, a percentage bar, etc.) may indicate how much warranty is left, as may a series of color-coded flags, or ranges (e.g. months, years, etc.). With regard to the warranty example, multiple displays may be made available in whole or in part (e.g. parts vs. labor, etc.).

As described above, certain example embodiments may moderate title transfers. Certain products come with product registration cards to be returned to the manufacturer. But once an item is sold, the manufacturer may be notified to remove any personal information associated with that product serial number, such as, for example, name, address, etc. obtained from the original warranty registration card. An option may be provided (potentially in the form of a checkbox) to allow the new owner to register the product with the manufacturer online. The ER database may track such information and/or the ER system may automatically convey transfers to manufacturers so that they can update their own records accordingly. Thus, titles, ownership, warranties, and the like may be transferable and/or purgable, as advantageously enabled by certain example embodiments. Moreover, manufacturers may offer certain perks beyond warranty protection to those users who opt to complete electronic title transfers.

It will be appreciated that all of these value-added features may become available to the user on the user's request or very actively as part of the initial inquiry into the status of the product. For example, direct links, phone numbers, and the like may be provided directly or upon an user-initiated event. The links may be made possible through the ER database, for example, as linked to via serial numbers, brand names, etc. Such information also may come standard as a part of a subscription fee paid by prospective buyers who want to be sure of their purchases.

One type of fraud involves posting products with duplicate valid serial numbers. The example embodiments herein may reduce the ability to post such products on online auction houses by, for example, requiring entries into the ER database to be based on unique data (e.g. unique serial number, unique UPCs, etc.).

Another scam relates to a situation where a seller may post an item without ever being in possession of it, even though the posting may have a valid serial number. The seller may abscond after receiving the transfer of money. Such systems also may advantageously reduce the availability of this scam by tracking unique serial numbers, distribution channels, rightful ownership, etc.

Certain similar scams relate to promises to return a product or non-payment of a delivered product. In such cases, certain example embodiments may provide systems for seller recourse. Certain example embodiments may allow a seller to flag the product and put a “lien” on it to prevent that item from being posted again. This ability also may provide a solution to buyer-seller reluctance to refund money before a product is returned, and vice versa. As noted above, a resolution center associated with the online auction house may have easy access to information to help resolve such buyer/seller issues.

Certain other example embodiments may leverage the ER database to function as a “Lost and Found” posting. Certain Lost and Found boxes are known, even in the online world. However, the example embodiments herein enable an added layer of protection and/or verification related to the information stored in the ER database. For example, that information may help to authenticate ownership before posting whether an item is lost and before delivering a claimed item. This also may enable possible rewards to be given more readily and willingly, from the ER clearinghouse and/or the rightful owner.

In such example embodiments, the authentication process may include a series of questions. For example, the user may be asked when and/or where the item purchased, whether there are certain identifying qualities to the item, etc. A user may be able to provide answers, either exact or within a tolerable range (e.g. within a one-week span). Thus, such example embodiments may reduce the ability to report missing products erroneously (e.g. as jokes, for fraudulent purposes, etc.) and/or to collect erroneous rewards.

The example embodiments described herein can add value to online auction houses' transactions for the buyer, seller, and auction house itself. For example, benefits to the seller relate to how the seller's listing may become more “valued” by buyers because of background information potentially available. The seller may obtain a premium price because of the value added by the example embodiments.

Benefits to the buyer relate to prior purchasing information for an item. The buyer may be able to verify a product's warranty entitlement status, determine if and where the product can be serviced locally, check available data to determine if it has been listed as stolen property, etc.

Benefits to the auction house relate to improvements in overall reputation. Posting of information may deter auctions of stolen merchandise and resolution centers may be able to more quickly resolve customer issues. Benefits to manufacturers may relate to pre-registration for producers of high-end or exclusive equipment (e.g. musical instruments, guitar makers, etc.), reduce unauthorized postings on online auction houses. Manufacturers (and/or product originator) may receive notification of any unauthorized transactions.

Such services may be provided for fees, such as, for example, transaction fees (e.g. per purchase, per view, etc.). However, frequent buyers and/or sellers may find it cumbersome to deal with a fee for each transaction or each time they view a product. A periodic subscription fee (e.g. weekly, monthly, yearly) may be provided instead of a transaction fee. A premium fee may be required for a potential to see all data. Still further, a buyer and/or seller may purchase a certain number of credits to use as the buyer and/or seller sees fit.

Similarly, manufacturers may be charged periodically (e.g. monthly, yearly, etc.), by transaction, etc. For service contracts, partners may be charged a percentage of each transaction or of total business, on a periodic basis (e.g. monthly, yearly, etc.) based on referrals, etc.

Although the example embodiments have been described in relation to products having serial numbers, the present invention is not so limited. For example, unserialized products may also take advantage of the techniques described herein by virtue of other unique and/or identifiable characteristics thereof. Furthermore, certain products are produced in such limited quantities that their mere existence may be self-authenticating and/or self-identifiable. Additionally, certain products are so tightly controller that their appearance via other channels may indicate a potential problem worthy of notification to a trusted authority (e.g. the auction house, a manufacturer, a trusted ER intermediary, etc.).

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the scope of the appended claims.

What is claimed is:

1. A system for electronic product registration, comprising:
an online auction house including a seller interface configured to accept product information for at least one product to be sold by at least one seller, and a buyer interface configured to allow at least one buyer to search for and/or purchase a product for sale by a seller to be bought by a buyer;
an electronic registration database including an entry for each of a plurality of products, the electronic registration database being populated with product information for each said product in the electronic registration database and being populated by at least one of a retailer, a manufacturer, an authorized party, and an auction house seller; and
an electronic registration clearinghouse configured to issue a certificate to certify for each product entered into the seller interface whether each said product should be offered for sale by the auction house in dependence on the product information stored in the electronic registration database,
wherein the auction house lists products having certificates for sale.

2. The system of claim 1, wherein an authorized party is a retailer, a law enforcement agency, and/or an insurance company.

3. The system of claim 1, wherein the product information accepted by the seller interface includes a brand, a model, a UPC, and/or a serial number for the product for sale.

4. The system of claim 1, wherein the buyer interface is configured to communicate to a buyer whether a product to be bought has a certificate associated therewith.

5. The system of claim 1, wherein the buyer interface is configured to display product information from the electronic registration database corresponding to the product to be bought.

6. The system of claim 5, wherein product information includes warranty information, an amount of time since the corresponding product's original sale, and/or a chain of title.

7. The system of claim 1, wherein the electronic registration clearinghouse is configured to notify one or more authorized parties if a product for sale by a seller does not have a certificate associated therewith.

8. The system of claim 1, wherein the electronic registration clearinghouse is configured to issue a certificate for a product for sale when the product information entered into the seller interface is within a predetermined range of acceptable values.

9. The system of claim 1, wherein the electronic registration database includes at least one flag associated with each entry, the flag indicating whether the product associated with the entry is a stolen good, a gray-market good, or a B-good.

10. A method of operating an online auction house, the method comprising:
accepting product information for a product to be sold by a seller from a seller interface of the online auction house;
comparing the product information for the product to be sold to product information stored in an electronic registration database populated with product information for a plurality of products, the electronic registration database being populated by at least one of a retailer, a manufacturer, an authorized party, and an auction house seller;
associating a certificate with the product to be sold in dependence on the comparing step; and
listing those products for sale that have certificates associated therewith.

11. The method of claim 10, wherein an authorized party is a retailer, a law enforcement agency, and/or an insurance company.

12. The method of claim 10, wherein the accepting step is further practiced by accepting a brand, a model, a UPC, and/or a serial number for the product for sale.

13. The method of claim 10, further comprising communicating to a buyer whether a product for sale has a certificate associated therewith.

14. The method of claim 10, further comprising displaying to a buyer product information from the electronic registration database corresponding to a product for sale.

15. The method of claim 14, wherein product information includes warranty information, an amount of time since the corresponding product's original sale, and/or a chain of title.

16. The method of claim 10, further comprising notifying one or more authorized parties if a product for sale by a seller does not have a certificate associated therewith.

17. The method of claim 10, further comprising issuing a certificate for a product for sale when the product information entered into the seller interface is within a predetermined range of acceptable values.

18. The method of claim 10, further comprising checking the electronic registration database for a flag indicating whether the product for sale is a stolen good, a gray-market good, or a B-good.

19. An electronic registration clearinghouse for use with an online auction house, comprising:
comparing programmed logic circuitry configured to compare product information for a product to be sold to product information stored in an electronic registration database populated with product information for a plurality of products, the electronic registration database being populated by at least one of a retailer, a manufacturer, an authorized party, and an auction house seller;
certifying programmed logic circuitry configured to issue a certificate to certify, for each product entered into a seller interface of the auction house, whether each said product should be offered for sale by the auction house in dependence on a comparison to product information stored in the electronic registration database.

20. The electronic registration clearinghouse of claim 19, further comprising notifying programmed logic circuitry to notify one or more authorized parties if a product for sale by a seller does not have a certificate associated therewith.
